(19) United States
(12) Patent Application Publication
(10) Pub. No.: US 2007/0264619 A1
(43) Pub. Date: Nov. 15, 2007

(54) SYSTEM AND METHOD OF JOB TRAINING AND JOB PLACEMENT FOR PERSONS WITH DEVELOPMENTAL DISABILITIES

(76) Inventor: Anne Hull, Leawood, KS (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/560,350

(22) Filed: Nov. 15, 2006

Related U.S. Application Data
(60) Provisional application No. 60/736,761, filed on Nov. 15, 2005.

(51) Int. Cl. G09B 19/00

(52) U.S. Cl. 434/219

(57) ABSTRACT

A system and methods of job placement are provided. Participants are exposed to an executive-type job setting, corporate-type job setting or other job setting that involves or is built on a relationship with customers or that involves social interaction in a controlled environment of a training facility/agency/foundation. Individualized training/support is provided that includes exposure in the job settings as well as public exposure in other manners such as through volunteer work, recreational activities, etc. Once a participant is placed outside the training agency, each participant is provided individualized ongoing support to ensure continued success of the placed participant.

This application claims priority pursuant to 35 U.S.C. 119(e) to co-pending U.S. Provisional Patent Application Ser. No. 60/736,761, filed Nov. 15, 2005, the entire disclosure of which is incorporated herein by reference.

### FIELD OF THE INVENTION

The present invention relates generally to job training and job placement. More specifically, the present invention is concerned with a system and methods of job training and job placement for persons with developmental disabilities.

### BACKGROUND OF THE INVENTION

Job training and job placement are very common aspects of life for most adults. Job placement often involves the matching of a prospective employee's relevant skills to the requirements for a particular job. Job training involves the teaching of skills to a person to help that person obtain and/or excel in a specific job. Job training can be accomplished either prior to obtaining a job, or “on the job” after the person has obtained (been placed at) the specific job. Traditional methods of job training typically focus on teaching skills that are specific to the specific job, and typically do not focus on teaching the social, interactive or interpersonal skills that are inherently necessary in many job settings (such as sales jobs). Furthermore, traditional methods of job training typically are intended for use with a large number of people, and do not take into account special or individualized training needs of certain trainees, such as training needs of persons with developmental disabilities. Traditional methods of job training typically focus on initial training with little or no ongoing training or support beyond the initial training. As such, most employers are not in a position to identify an employee's difficulties until they reach a point of causing a disruption to the employee's work performance. In many cases involving persons with developmental disabilities, what may have started as a minor difficulty can evolve into a major disruption when not addressed in a timely manner. This can then result in the destruction of the employer/employee relationship, and worse, result in the employer deciding to refrain from hiring other persons with developmental disabilities in the future.

As a result, persons with developmental disabilities typically are placed only at jobs that require little if any social, interactive or interpersonal skills, and/or jobs that require no individualized training. For example, many persons with developmental disabilities are placed at workshops in which they work with other persons having developmental disabilities. Workshop jobs typically are jobs that do not require individualized training and that do not involve any social interaction with a customer. A typical workshop job involves assembling or packaging items in an assembly-line or factory type setting. Workshop employees typically only interact with other workshop employees. Another typical job for persons with developmental disabilities is housekeeping or custodial jobs, in which cleaning services are performed when most businesses are closed or lightly staffed. Although, such assembly-line and custodial jobs are often performed by persons with and without developmental disabilities alike, limiting persons with developmental disabilities to such jobs tends to limit those persons' social interaction to interaction only with other persons with developmental disabilities. Therefore, it would be beneficial to provide a system and methods of job training and job placement for persons with developmental disabilities, that allow such persons to obtain and maintain jobs that require more specialized and/or interactive skills, such as sales jobs, and/or that allow persons with developmental disabilities to work in a job environment that is not limited to only persons with developmental disabilities.

### SUMMARY/DESCRIPTION OF THE INVENTION

An object of the present invention is to provide a system and methods of job training and job placement for persons with developmental disabilities. Another object of the instant invention is to provide a system and methods of job training and job placement for persons with developmental disabilities that allow such persons to obtain and/or maintain jobs that require specialized and/or interactive skills, such as sales jobs. Yet another object of the instant invention is to provide a system and methods of job training and job placement for persons with developmental disabilities that allow persons with developmental disabilities to work in a job environment that is not limited to only interactions with other persons with developmental disabilities. Still another object of the instant invention is to provide a system and methods of individualized and/or customized job training and job placement for persons with developmental disabilities.

The objects of the instant invention are accomplished through the use of a system and methods of job training and job placement that provide persons with developmental disabilities (“participants”) individualized training and/or experience in job settings that require and/or promote social interaction with customers. Each participant is exposed to an executive-type job setting, corporate-type job setting or other job setting that involves or is built on a relationship with customers or that involves social interaction. This exposure is accomplished in a somewhat controlled environment of a training facility/agency/foundation, in which individualized training/support can be provided that includes exposure in the job settings as well as public exposure in other manners such as through volunteer work, recreational activities, etc. This exposure promotes an entrepreneurial attitude among participants and also creates awareness of the participants and their job skills to the outside community resulting in job placement outside the training agency. Once a participant is placed outside the training agency, each participant is still provided individualized ongoing support to ensure continued success of the placed participant.

In one embodiment of the instant invention, each participant is provided or offered exposure to several different job settings by the training agency. One such setting is as an employee of a retail store that is run by the training agency. In the retail store, the participant works as a store clerk, interacting with and/or greeting customers of the store, answering questions regarding items for sale, ringing up purchases, taking payment (cash, check, credit card), stocking inventory, making gift baskets, pricing items, packaging and/or wrapping items, cleaning, promoting the store and its products, preparing advertisements, preparing sales strategies, preparing displays, and other jobs associated with the operation of a retail store. Another setting is as a member of a sales/marketing team for product delivery service that is run by the training agency.

Participants are provided exposure to job settings in a controlled environment that is run by the training agency, such as in the job settings described above. In each of the above job settings, participants are organized into teams of generally 3 participants (as opposed to 10 or 12 in a workshop setting) with one team leader that is an employee of the training agency. The team leader provides individualized training and/or support for participants of the team depending upon the individual participant's needs. In the example of the product delivery service, the team leader is the driver of the team, and supervises the sales team primarily in case of emergency and also to provide live cues to participants if needed. In the example of the retail store, the team leader may be a store manager.

The cues provided by a team leader vary depending upon the situation, the job setting (i.e. retail store or product delivery service), and the individual participant and have different levels depending upon the desired result. Some cues may be a simple word to the participant, or a card that is held up by the team leader. The cues provide a participant who is straying off task a reminder as to the task that is to be accomplished, how the task is to be accomplished, or of a behavior or attitude that is required by the participant. In some cases cues are visual marks for a participant, such as a label on a delivery cart as to the items that are to be placed in the cart, or the cost of specific items, etc.

Teams are organized based upon individual team member skills, team leader skills and team group dynamics, to match all members of the team (including participants and team leader) based upon specific strengths of each individual. For example, if a team leader is not particularly outgoing, that team leader will be matched with participants that are more outgoing, and vice-versa. In the example of the product delivery team, certain members of the team will keep track of the money, while others will package and prepare the products.

Once a participant is placed outside the training agency, support similar to that provided while the participant was working in the controlled environment of the agency is provided to the participant on an ongoing basis. For example, the team leader, or another employee of the training agency will perform follow-along services such as contacting or meeting with the participant to see if the participant needs any assistance or has any questions or concerns regarding the participant's job. The employee may also contact or meet with the participant's employer to see if the employer has any comment, questions or concerns regarding the participant. As the training agency has previously worked with the participant in a job setting, the employees of the agency will be familiar with the individual participant's behavior and therefore be in a position to address or create customized/individualized solutions for any concerns. The follow-along services preferably will continue indefinitely. The type of follow-along and the frequency will depend upon the individual participant. For example, some participants may require only minimal follow-along, such as a telephone call twice a month with the participant to make sure there are no problems, while other participants may require face-to-face meetings once per week (or more often) as well as routine meetings with the employer. The training agency will be in a position, based upon the agency's prior history with the participant, to customize creative follow-along services for an individual participant. This helps to participant maintain a consistent work environment and continued employment. The ongoing support (while the participant is in a job setting of the agency, as well as the follow-along support) provided by the agency provides credibility for the agency and the participant within the business community.

The type of ongoing support can include either job-task assistance, social/interrelational assistance, or both. For example, in a situation in which a participant is hired as a stock-person in a store, the support might involve instruction in how to stock the shelves. With respect to social assistance, the support may involve issues such as proper hygiene while at work, i.e. reminding the participant to wear deodorant, or if the job involves close interaction and conversations with others, reminding the participant to use breath mints, etc.

In addition to providing the participants with a socially interactive job setting, the training agency provides participants with a wide range of opportunities and choices for the participants to enrich their experience in the community, such as volunteering at nursing homes, pet stores, etc.; participating in preparation and conducting of a community party; exercise; and other recreational activities. In addition to promoting community involvement and well-rounded lifestyles, this teaches the participants, and/or familiarizes them with, balancing a daily schedule. Furthermore, the community involvement results in awareness by the community and local businesses in the training agency and the participants, which helps to further promote additional interaction with the community.

While working in a job setting at the training agency, participants will set their schedules partly based upon individual decisions and partly based upon team decisions. For example, a participant may chose to participate in the product delivery team, and the product delivery team participants will then as a group make decisions regarding the service (i.e. which team member handles the money, which team members makes sales offers, etc.). Participants may be members of several different teams. Typically, a participant's calendar will be set up a week at a time, and broken into morning, lunch and afternoon. A participant may be part of one team (such as product delivery) for the morning and part of another team (such as working in the store, or exercising, etc.) for the afternoon, etc. Each activity on the participant's calendar will often have an individual set of requirements, such as dress code (i.e. a uniform for the delivery service, or workout clothes for exercising). Schedules for the participants are typically set at a weekly meeting in which team leaders and participants discuss the upcoming week, cues, reminders etc. Teams are not necessarily broken into grouping based on team activities (i.e. product delivery, exercise, etc.), but are broken into groups based on team leader. Thus, multiple teams may actually be performing the same activities. The team leaders and teams will consult with each other to coordinate schedules so that two teams do not interfere with each other's activities.

Unlike systems and methods of the prior art, in which persons with learning disabilities are typically labeled as “special people” and given limited opportunities (considered special activities) for social interaction that takes place only in large groups of other people with similar disabilities, the activities scheduled on a participants calendar in the instant invention are daily, or multiple times during a day and on a continuous and regular basis. Such continuous daily activities help to promote productivity and friendship. As a result participants learn to lead productive lives as citizens of the community.

The system and methods of the instant invention result in participants being invested in the success of the team and in feeling an ownership in the work being performed in the job setting. Participants learn job task skills as well as social and behavior skills, which help the participants qualify for and maintain jobs outside the training agency. Each participant is provided business cards and control over team/job setting that add to this feeling of ownership/investment. Participants are given a feeling of job satisfaction that continues into the positions taken outside the training agency.

In one preferred embodiment of the instant invention, a central training agency (such as a franchiser) provides training and support for other sub-agencies (such as franchisees) to implement the system and methods of the instant invention described herein. In such an embodiment, the central agency provides the sub-agencies with policies and procedures, forms, descriptions, directions, quality assurance manuals, etc. to enable the sub-agency to quickly and easily establish and maintain the ability to carry out job training and job placement. By way of example only, the central agency may provide procedures on appropriate equipment/items to be taken by teams when performing the product delivery service. Such items may include: duct tape, first aid kit, tool kits, floor plans of buildings in which delivery will be made, maps, emergency drill specifications for places in which delivery will be made, employee manual, release forms for participants, delivery carts, and travel files for participants in the delivery team (including items such as releases, medical information identification, insurance cards, medications, etc.). In addition, the central training agency may provide sub-agencies guidance in how to obtain certification and funding (such as grants for mini-vans for the delivery service, how to utilize grant money from community businesses, etc.).

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Benefits and features of the preferred embodiment of the system and methods of the instant invention include:
Person Centered Planning assures that each individual participant makes his/her own choices regarding life goals:
   Participants have regular weekly meetings which impacts their schedules
   Reality Based Training
Provide regular fitness training
Community Interactive: large percentage of day in the community working, exercising, volunteering, socializing and enjoying recreational activities.
Provide activity transition every 40-50 minutes. Days are very active
Teams are small: Normally 3 participants with 1 Team Leader
use mini-vans for transportation
Provide competitive Employment Opportunities:
   Job Development
   Job Placement
   Job Coaching
   Follow Along
Participants working in agency store and/or product delivery service are paid on commission of sales
Interact with over 300 people a week
working in the professional business world
learning retail and sales commission skills
Staff skills are matched with individuals and activities
Not a workshop environment

In the preferred embodiment of the instant invention, the training agency offers a participant job skill training and community exposure in a product delivery service job setting and/or in a retail store setting.

Product Delivery Service:

The product delivery is designed to create opportunity for interaction with individuals in business settings. Sales teams, which include three staff members and a staff team leader take carts filled with snack items to ‘prearranged’ weekly appointments. The team sells specially wrapped items to the workers at a business. The primary goals are to “Make friends in the business community and to learn skills which are applicable to all employment settings.” Each of the participants has their own business cards reflecting his/her position in the organization.

Individuals who participate in delivery service actually package the items, wearing gloves with strict attention to cleanliness, as well as hygiene skills. They learn to weigh each package, close and label the product neatly, arrangement of the “goodies” on the carts, sales and social skills with customers appropriate in the corporate business office setting. Expectations, regarding time management, quality packaging and appropriate social skills are involved. The participants are paid for the work they do independently. This helps the participants to become completely independent in jobs using these skills outside of the training agency. Participants also are paid commission for all sales which are produced in the delivery program, giving a sense of ownership to the participants. The participants in the product delivery service will often deliver products and interact with persons at businesses that are potential employers for participants to become employed outside of the training agency.

Retail Store:

Merchandise sold in the store ranges from antique furniture and collectibles to new gift items such as candles, note pads, decorative items, artificial floral arrangements, gift baskets and pictures. Participants work as employees in the store and interact with customers.

Both the product delivery service and the retail store provide participants exposure to job settings in which the participants interact with customers. In addition, the participants learn job skills (task skills and social skills) in the controlled environment of the training agency that can be utilized in jobs outside the training agency. In the controlled environment, the participants can be taught using cues by team leaders that are customized for the particular individual based upon the participant's personality and particular learning disability.

The product delivery service and the retail store provides participants exposure to the community, allowing the participants to showcase their job task and social skills to potential employers. In addition, the training agency provides participants additional opportunities to get involved in the community such as volunteering at nursing homes, pet stores, etc.; participating in preparation and conducting of a community party; exercise; and other recreational activities. In addition to enriching the participant's lives, this too allows participants opportunity to interact with potential employers. In addition, the training agency contacts potential employers to inquire about potential jobs for participants outside of the agency.

The agency provides job development and job coaching assistance for participants to obtain jobs outside the training agency. A job developer, which is an employee of the training agency (and may or may not be the same person that is a team leader), will contact a potential employer to obtain information regarding a job opening. The information includes a job description and specific job task requirements, needs, etc. The job developer establishes a relationship between the employer and the training agency. A job coach, which is also an employee of the training agency (and may or may not be the same person as the job developer), then can work with the job developer's information to help a participant obtain and maintain the job.

The job coach helps a participant obtain a job by putting together a resume and assisting in preparation for a job interview. In addition, because the job developer has obtained information regarding the job description and job task requirements, the job coach can assist the participant by teaching the participant specific skills that will be necessary for the job. The job coach and/or job developer may also assist the participant by introducing the participant to the potential employer and/or by participating in the interview process.

In the preferred embodiment, before or once a participant is offered employment by a business outside the training agency, the job coach will visit the place of employment (either alone, or with the participant) and observe, examine, learn and/or evaluate the specific job tasks that will be required to be performed by the participant. The job coach will then teach the participant that has been hired the specific job tasks (and any social skills) required for the job. The job coach may break down the tasks into smaller tasks that are easier to teach. The manner in which a job coach teaches the job tasks will depend upon the specific tasks required and upon the particular personality and learning disability of the participant that is to be employed.

The job coach will also provide the participant ongoing support while the participant is employed outside the training agency. The type of support and extent of support will depend upon and be customized for the individual participant. The job coach will utilize the particular knowledge learned about the job as well as knowledge learned about the participant while the participant was employed by the agency to develop an appropriate support plan. By way of example, if a participant is employed as a stock-person, the job coach may visit the participant's place of employment on a regular basis (i.e. once a week, twice a month, etc.—depending upon particular participant's needs) and inspect the participant's work, such as checking quality of the participant's performance of job tasks (i.e. whether the items are placed on the shelves properly). The job coach's inspection of a participant's performance takes place on a regular basis over relatively short time intervals so that the job coach can identify problems before they reach a level of disruption that might result in termination of the participant from the employment.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of job placement comprising:
exposing a participant to a job setting while in a controlled environment;
providing said participant individualized support within said controlled environment;
placing said participant in a job outside said controlled environment; and
providing said participant support while employed outside said controlled environment.

2. The method as claimed in claim 1 wherein said support is ongoing while said participant is employed outside said controlled environment.

3. The method as claimed in claim 1 wherein said participant is a person with a learning disability.

4. The method as claimed in claim 1 wherein said support comprises a cue.

5. The method as claimed in claim 1 wherein said job setting in said controlled environment includes social interaction with a customer.

6. The method as claimed in claim 5 wherein said job setting comprises a product delivery service.

7. The method as claimed in claim 5 wherein said job setting comprises a retail store.

8. The method as claimed in claim 1 further comprising the step of exposing the participant to the public through an extracurricular activity.

9. The method as claimed in claim 8 wherein said extracurricular activity is selected from the group comprising volunteer work, exercise, recreation, socializing and planning a party.

10. The method as claimed in claim 1 further comprising the step of assembling multiple participants into a team in said controlled environment.

11. The method as claimed in claim 10 wherein said team includes a team leader that is an employee of a training agency.

12. The method as claimed in claim 1 wherein said controlled environment is controlled by a training agency.

13. The method as claimed in claim 12 wherein said step of providing said participant support while employed outside said controlled environment is performed by an employee of said training agency.
